(19) United States
(12) Patent Application Publication
(10) Pub. No.: US 2002/0084749 A1
(43) Pub. Date: Jul. 4, 2002

(54) UV reflecting materials for LED lamps using UV-emitting diodes

(76) Inventors: Raul E. Ayala, Clifton Park, NY (US); Jon Bennett Jansma, Pepper Pike, OH (US)

Correspondence Address: Timothy E. Nauman, Esq., Fay, Sharpe, Fagan,, Minnich & McKee, LLP, 1100 Superior Avenue, 7th Floor, Cleveland, OH, 44114-2518, US

(21) Appl. No.: 09/845,655

(22) Filed: Apr. 30, 2001

Related U.S. Application Data
(63) Continuation-in-part of application No. 09/750,559, filed on Dec. 28, 2000.

(51) Int. Cl. H05B 33/22

(52) U.S. Cl. 313/512

(57) ABSTRACT

A light source comprising a light emitting component comprised of a semiconductor material, at least one phosphor material, at least one UV reflecting material, and optionally, at least one silicone layer and at least one encapsulant, is provided. This light source provides safety to the user against UV exposure and protection to other components within the device that may degrade upon exposure to UV radiation. Furthermore, the UV reflecting material reflects unconverted UV light back into the phosphor layer where it is converted to visible light, resulting in increased output from the light source.

This application is a continuation-in-part of U.S. Ser. No. 09/750,559 filed Dec. 28, 2000.

### BACKGROUND OF THE INVENTION

This invention relates to light emitting devices comprising a light emitting diode or laser diode each of which may be hereinafter referred to as “LED”, an excitable phosphor, and a UV-reflecting material. It finds particular application in combination with a UV/Blue LED and a phosphor or blend of phosphors. The present invention provides safety to the user against UV exposure and protection to other components within the device that may degrade upon exposure to UV radiation, while increasing the UV-to-visible conversion efficiency of the lamp.

Light emitting diodes and lasers have been produced from Group III-V alloys such as gallium nitride (GaN). To form the LEDs, layers of the alloys are typically deposited epitaxially on a substrate, such as silicon carbide or sapphire, and may be doped with a variety of n and p type dopants to improve properties, such as light emission efficiency. With reference to the GaN-based LEDs, light is generally emitted in the UV and/or blue range of the electromagnetic spectrum.

Recently, techniques have been developed for converting the light emitted from LEDs to useful light for illumination purposes. By interposing a phosphor excited by the radiation generated by the LED, light of a different wavelength, e.g., in the visible range of the spectrum may be generated. Often, a combination of LED generated light and phosphor generated light may produce the visible light (e.g. white).

In this regard, white LEDs which employ a combination of a UV/blue LED with one or more phosphors to provide a white color, suffer from at least one drawback. Particularly, not all of the UV light emitted by the LED is converted in the phosphor to visible light. This means UV radiation escapes from the LED device into the environment. Unfortunately, UV light may be harmful to humans. Also, UV light can lead to degradation of various mechanical parts of the light emitting device and even its surroundings.

An optimum configuration for a UV-based LED lamp is one in which all the UV radiation emitted by the diode is converted into white light. However, this may not be achievable in practice, and many modes of operation exist between the following two sub-optimal cases.

First, some of the UV radiation emitted by the diode may go through the phosphor layer unconverted and escape the lamp along with the visible light. This case may happen, for instance, when the phosphor layer is too thin or when the UV-to-visible conversion efficiency by the phosphor is too low due to sub-optimal phosphor particle size or morphology.

Second, some of the converted visible light may be re-absorbed by the phosphor layer, resulting in a less than optimum light output by the lamp. This case may happen if, for instance, the phosphor layer is too thick or, again, if the phosphor particle size or phosphor layer morphology is sub-optimal.

Accordingly, it would be highly desirable to have a means of preventing the UV radiation from leaving the lamp, both from the standpoint of safety (exposure to users) and of possible degradation of other components that are sensitive to UV radiation, while also increasing the UV-to visible conversion efficiency of the lamp.

### SUMMARY OF THE INVENTION

In an exemplary embodiment of the present invention, a light source is provided. The light source comprises a light emitting component, at least one phosphor material, at least one UV reflecting material, and optionally, at least one silicone layer and/or encapsulant. The UV reflecting material redirects the UV light emitted by the LED which is not converted to visible light in the phosphor back into the phosphor, where at least a portion is converted to visible light.

In another exemplary embodiment of the present invention, a light source with decreased UV emission is provided. The light source includes a light emitting component, at least one phosphor material, at least one LV reflecting layer containing alumina, and, optionally, at least one silicone layer and/or encapsulant.

In yet another exemplary embodiment of the present invention, UV light unconverted to visible in the phosphor layer is reflected by the UV reflecting layer back into the phosphor, where it is then converted to visible light. This increases the lumen output of the light source.

Still further embodiments of the present invention will become apparent to those of ordinary skill in the art upon reading and understanding the following detailed description of the various embodiments.

### BRIEF DESCRIPTION OF THE DRAWINGS

FIG. 1 is a schematic sectional view of a lamp employing the UV reflecting material of the present invention as a layer adjacent to the phosphor.

FIG. 2 is a schematic view of an alternative embodiment of a lamp according to the present invention. In this embodiment, the UV reflecting material is disposed as a layer on the surface of the light emitting device.

FIG. 3 is a schematic view of yet another alternative embodiment of a lamp according to the present invention. In this embodiment, the UV reflecting material is disposed within the encapsulant layer.

FIG. 4 is a schematic view of a fourth embodiment of the present invention. In this embodiment, the UV reflecting material is disposed within the phosphor layer.

### DETAILED DESCRIPTION OF THE INVENTION

The present invention focuses on the inclusion of a UV reflecting material in any configuration of a light source containing a light emitting diode or laser diode. As used herein, the term “light” encompasses radiation in the UV, IR, and visible regions of the electromagnetic spectrum.

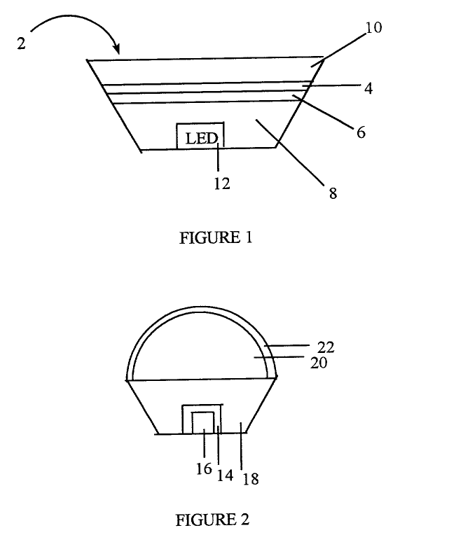

With reference to FIG. 1, a schematic view of a light source 2 is shown. The UV reflecting layer 4 is located adjacent to the phosphor layer 6. The phosphor layer 6 and the UV reflecting layer 4 are placed between two encapsulant layers 8 and 10. The LED 12 is surrounded by an encapsulant layer 8. The phosphor layer 6 is excited by a UV/blue light emitted by the LED 12 and converts that light to visible white light. If all of the UV light is not converted, and a fraction of the UV light escapes the phosphor layer 6, at least a portion of the unconverted UV light is then reflected by the UV reflecting layer 4 back into the phosphor layer 6. Importantly, a significant portion of the visible white light is allowed to pass through the UV reflecting layer and out of the light source 2. For example, at least about 90% of the visible light, e.g. about 400-700 nm will pass through.

With reference to FIG. 2, the phosphor layer 14 is disposed directly adjacent the LED 16. The phosphor layer 14 is then encapsulated by silicone layer 18. This encapsulant is then topped with a further encapsulant 20. The UV/Blue light emitted from the LED 16 passes into the phosphor layer 14. The phosphor layer 14 is excited by the light emitted from the LED 16 and converts a significant portion to visible white light. If all of the UV light is not converted to visible white light by the phosphor layer 14, that portion of the UV light which remains unconverted passes through the two encapsulant layers 18 and 20, and is reflected back into the phosphor layer by the UV reflecting layer 22. The UV reflecting layer 22 reflects a significant portion of the UV light but allows a significant portion of the visible white light to pass through and exit the light emitting device.

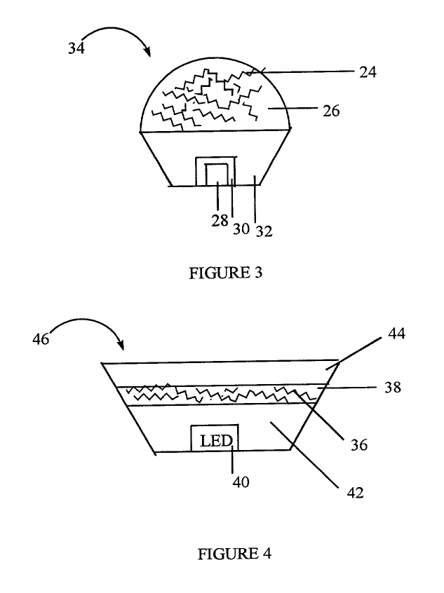

With reference to FIG. 3, the UV reflecting material 24 is disposed in the encapsulant 26. The light emitted from the LED 28 passes through the phosphor layer 30 where it is converted to visible light. The light then passes through the silicone layer 32 and into the encapsulant 26. If any UV light remains unconverted by the phosphor material 30, it is reflected by the UV reflecting material 24 disposed in the encapsulant 26 back into the phosphor layer 30. The visible light then exits the light source 34.

With reference to FIG. 4, the UV reflecting material 36 is disposed in the phosphor layer 38. Light is emitted from the LED 40, and passes through the first encapsulant layer 42 and into the phosphor layer 38 where it is converted to white light. Any unconverted UV light is reflected by the UV reflecting material 36 within the phosphor layer 38 and the visible light passes from the phosphor layer 38 and into the second encapsulant 44 before leaving the light source 46.

Notwithstanding the depicted embodiments, the skilled artisan will recognize that any LED device configuration may be improved by the inclusion of the present inventive UV reflecting layer. The embodiments specifically described herein are meant to be illustrative and should not be construed in any limitative sense.

With specific reference to the UV reflecting material, the UV reflector may comprise a separate layer composed of a matrix material into which a UV reflecting material is disposed (e.g. FIGS. 1 and 2). Alternatively, the UV reflector may be incorporated into a traditional device layer (e.g. FIGS. 3 and 4). In addition, the phosphor could be suspended in the reflector matrix.

If the UV reflector material is a component of the encapsulant, then the encapsulant material is preferably also resistant to UV degradation. Suitable encapsulant materials which are resistant to UV degradation include silicone, polymethyl-methacrylate, and polycarbonates, e.g. Lexan®.

However, many traditional LED driven light emitting devices use materials which are subject to UV degradation. A common encapsulant material is aromatic epoxies which degrade quickly in the presence of UV light. In an embodiment which required the use of aromatic epoxies as an encapsulant, the UV reflecting material would preferably be in the form of a layer between the phosphor and the encapsulant as in FIG. 1 to help protect these degradable materials.

The UV reflecting materials, when properly located within the lamp, will redirect the unconverted UV radiation back to the phosphor layer preventing the escape of unconverted UV radiation from the lamp and improving the UV-to-visible conversion efficiency of the phosphor layer within the lamp.

The preferred UV reflecting materials are alumina containing compounds. Alumina compounds will reflect UV light. Any aluminum containing materials which do not chemically interact with the phosphor material are therefore preferred. In addition, silica (SiO₂) and/or yttrium (Y₂O₃) may be used as the UV reflecting material—alone or in combination with the aluminum containing materials. The UV reflecting material may contain alpha alumina, gamma alumina, and mixtures thereof The preferred material contains between about 5-80 weight percent gamma alumina and between about 20-95 weight percent alpha alumina. The exact composition will depend on the best reflectance that alumina has for the UV emission wavelength of LED's. The preferred wavelength to be reflected is between about 300 and 400 nm, more preferably between about 325 and 400 nm, and most preferably between about 360 and 390 nm. It is important that the UV reflecting material be capable of reflecting at least about 90% of the UV light not converted in the phosphor, more preferably greater than about 95%, and most preferably greater than about 98%.

The addition of a UV reflecting material such as alumina to an LED increases the output of the light source. This is a result of unconverted UV light being redirected to or within the phosphor layer, resulting in a greater conversion ratio within the phosphor layer, and, therefore, greater overall lamp output.

Other locations of the UV reflecting layer are possible, where the reflective layer is not necessarily next to or mixed with the phosphor, but a certain distance away from it to maximize lamp performance. For instance, several UV lamps placed next to each other could share the same UV-reflective layer coated on a covering transparent surface, such as glass, encompassing several LED dies at the same time. This configuration is akin to placing LED dies inside a linear fluorescent light bulb. The use of a UV reflecting material such as alumina containing compounds also leads to soft, diffuse light output similar to that of fluorescent lights.

The phosphor material may include more than one phosphor, such as two or more different phosphors (fluorescent materials). When the phosphor material includes two or more different phosphors, they are preferably mixed together in the coating. Alternatively, the different phosphors are layered in the coating.

A variety of phosphors may be used in the present invention to form the phosphor material. Where more than one phosphor is used in the phosphor material, the phosphors may be mixed together in a single layer, or separately layered to form a multi-layer coating on the window, on the chip, or elsewhere in the lamp. Other arrangements are also contemplated. For example, the phosphors may be arranged in different regions and the light emitted from each region combined to form the resulting output. The product of the phosphor grain density and grain size is preferably high enough to ensure that most of the UV light is converted to visible light.

Phosphors to be used in a phosphor blend in the light source preferably have the following attributes:

1. Lumen Maintenance. Ideally, the phosphor is one which has a good maintenance to light so that its fluorescent properties are not degraded when used over an extended period of time.

2. Capability of emitting light with a high efficiency.

3. Temperature resistance, if located in the vicinity of the LED.

4. Weatherablility in the operating environment of the light source.

The phosphors that comprise the phosphor material are substances which are capable of absorbing a part of the light emitted by the LED and emitting light of a wavelength different from Heat of the absorbed light Preferably, the phosphors convert a portion of the light emitted from the LED to light in the visible region of the electromagnetic spectrum. In a UV/blue LED, the phosphor is used to convert a majority of the UV portion of the light emitted from the LED to useful light in the visible region of the spectrum, and may also convert a portion of the blue light to longer wavelengths.

The color of the light emitted by the lamp is dependent on the selected mixture of phosphors in the phosphor mixture and on the emission spectrum of the LED. By selection of the type of LED used and the phosphor(s) in the phosphor material, light of a preselected color, such as white light, can be achieved. If the UV reflecting material is disposed within the phosphor layer, as seen in FIG. 4, the concentration of the UV reflecting material should not be greater than about 25%, preferably no greater than about 20%.

Light emitting components suited to use in the present invention include but are not limited to GaN-based (InAlGaN) semiconductor devices. Suitable GaN semiconductor materials for forming the light emitting components are generally represented by the general formula In_{I}Ga_{J}Al_{K}N, where I, J, and K are each greater than or equal to zero, and I+J+K=1. The nitride semiconductor materials may thus include materials such as AlGaN, AlIGaN, InGaN and GaN. If desired, these semi-conductor materials may be doped with various impurities for improving the intensity or adjusting the color of the light emitted. Laser diodes are similarly formed form an arrangement of GaN layers. Techniques for forming LEDs are well known in the art.

GaN based light emitting devices are capable of emitting light with high luminance. A suitable GaN-based LED device includes a substrate layer formed from a single crystal of, for example, sapphire, silicon carbide, or zinc oxide. An epitaxial buffer layer, of, for example n′ GaN is located on the substrate, followed by a sequence of epitaxial layers comprising cladding layers and active layers. Electrical contact is made between two of the layers and corresponding voltage electrodes (through a metal contact layer) to connect the LED to the circuit and source of power.

The wavelength of light emitted by an LED is dependent on the configuration of the semiconductor layers employed in forming the LED. As is known in the art, the composition of the semiconductor layers and the dopants employed can be selected so as to produce an LED with an emission spectrum which closely matches the excitation (absorption) spectrum of the phosphor material.

While the invention is described with particular reference to UV/blue light emitting components, it should be appreciated that light emitting components which emit light of a different region in the electromagnetic spectrum may also be used. For example, a red-emitting light emitting diode or laser diode, such as an aluminum indium gallium phosphate (AlInGaP) LED, emits light in the red region of the spectrum. Of importance is that any UV light emitted by the light source, and not converted by the phosphor, is reflected back into the phosphor layer by the UV reflecting material. Nonetheless, the invention is seen as particularly beneficial when employing an LED emitting in the 350-400 nm range.

The invention has been described with reference to the preferred embodiment. Obviously, modifications and alterations will occur to others upon reading and understanding the preceding, detailed description. It is intended that the invention be construed as including all such modifications and alterations insofar as they come within the scope of the appended claims or the equivalents thereof.

We claim:

1. A light source comprising:
a. a light emitting component comprised of a semiconductor material,
b. at least one phosphor material, and
c. at least one UV reflecting material.

2. The light source of claim 1 wherein the light emitting component comprises a light emitting diode or a laser diode.

3. The light source of claim 2 wherein the light emitting component emits light in at least one of the blue region and the UV region of the electromagnetic spectrum.

4. The light source of claim 1, wherein said phosphor is excited by light emitted from the said light emitting component.

5. The light source of claim 1 wherein said phosphor converts UV light to visible.

6. The light source of claim 1 wherein said UV reflecting material reflects UV light into the phosphor layer.

7. The light source of claim 1 wherein said UV reflecting material reflects at least a substantial portion of UV light emitted by said light emitting component.

8. The light source of claim 1 wherein said UV reflecting material reflects at least 90% of any UV light not converted to visible light by said phosphor.

9. The light source of claim 1 wherein said UV reflecting material comprises alumina.

10. The light source of claim 1 wherein said UV reflecting material comprises alpha alumina, gamma aluminum, and mixtures thereof.

11. The light source of claim 10 wherein said UV reflecting material contains about 5-80 wt % gamma alumina and about 20-95 wt % alpha alumina.

12. The light source of claim 1 wherein said UV reflecting material is disposed as a layer adjacent to the phosphor.

13. The light source of claim 1 wherein said UV reflecting material is disposed as a layer adjacent a layer of a transparent material.

14. The light source of claim 1 wherein said UV reflecting material is dispersed in a phosphor containing layer.

15. The light source of claim 14 wherein the concentration of UV reflecting material dispersed throughout the phosphor is not greater than about 25% by volume of said phosphor.

16. The light source of claim 1 wherein said UV reflecting layer reflects light in the range of about 350-400 nm.

17. The light source of claim 1 wherein said phosphor layer converts light reflected by the UV reflecting layer to visible light.

18. A white light emitting device comprising:
a. a light emitting diode,
b. at least one phosphor containing layer,
c. at least one UV reflecting material containing layer, and
d. at least one encapsulant layer, said UV reflecting material containing layer disposed outwardly from said phosphor containing layer.

19. A light emitting device comprising:
a. an LED of the formula In_{I}Ga_{J}Al_{K}N, wherein I, J, and K are each greater than or equal to zero, and I+J+K=1,
b. a phosphor layer, and
c. an encapsulant layer including a UV reflecting material and/or a UV reflecting layer.
